(19) United States
(12) Patent Application Publication
(10) Pub. No.: US 2017/0315522 A1
(43) Pub. Date: Nov. 2, 2017

(54) VIRTUAL SIMULATOR AND BUILDING MANAGEMENT SYSTEM INCLUDING THE SAME

(71) Applicant: SAMSUNG SDS CO., LTD., Seoul (KR)

(72) Inventors: Oh-Hyuk KWON, Seoul (KR); Ji-Hoon SONG, Seoul (KR)

(73) Assignee: SAMSUNG SDS CO., LTD., Seoul (KR)

(21) Appl. No.: 15/498,664

(22) Filed: Apr. 27, 2017

(30) Foreign Application Priority Data
Apr. 27, 2016 (KR) 10-2016-0051389

(51) Int. Cl. G05B 17/02; H04L 12/24; H04L 29/12; H04L 12/46

(52) U.S. Cl. CPC G05B 17/02; H04L 61/2007; H04L 12/4641; H04L 41/145; H04L 61/6022

(57) ABSTRACT

A virtual simulator and a building management system including the same are provided. The virtual simulator connected to a plurality of physical controllers, controlling at least one piece of equipment in a building, and a control server, controlling the plurality of physical controllers, for simulating operations of the plurality of physical controllers, the virtual simulator comprising: a plurality of virtual controllers, each virtual controller of the plurality of virtual controllers corresponding to a corresponding physical controller of the plurality of physical controllers and being configured to perform a same function as the corresponding physical controller, wherein the plurality of virtual controllers are configured to communicate with the plurality of physical controllers and the control server by using different Internet protocol (IP) addresses; and a virtual controller management agent configured to perform at least one among generation, deletion, execution, termination, detection, and control of the plurality of virtual controllers.

### CROSS-REFERENCE TO RELATED APPLICATION

This application claims priority to and the benefit of Korean Patent Application No. 10-2016-0051389, filed on Apr. 27, 2016, the disclosure of which is incorporated herein by reference in its entirety.

### BACKGROUND

### 1. Field

Embodiments relate to a virtual simulator which virtually simulates an operation of a physical controller and a building management system including the same.

### 2. Discussion of Related Art

A building management system is a system which manages and controls various pieces of equipment (or facilities), such as an air conditioner, a heating and cooling device, and a light, in a building using a central control server. To manage and control the equipment, one or more controllers should be installed in the building. Furthermore, in order to efficiently manage the building, an integration test should be conducted on the building management system using the one or more controllers.

However, generally, such an integration test can be conducted after construction of a building and electrical constructions are completed. In a related art, a large number of preparatory operations should be performed prior to an integration test after a system database (DB) is built according to the plan of a building. The preparatory operations depend on a process of constructing the building and require a large amount of time. Thus, conventionally, it is likely that establishing and testing of a building management system, which are conducted at the last stage of the process of constructing the building, will be delayed or unsatisfactorily completed. Accordingly, time may be unnecessarily wasted and engineers may be inefficiently managed.

### SUMMARY

Embodiments are directed to a means for efficiently establishing and testing a building management system using a virtual simulator without installing a physical controller.

According to an exemplary embodiment, there is provided a virtual simulator connected to a plurality of physical controllers, controlling at least one piece of equipment in a building, and a control server, controlling the plurality of physical controllers, for simulating operations of the plurality of physical controllers, the virtual simulator comprising: a plurality of virtual controllers, each virtual controller of the plurality of virtual controllers corresponding to a corresponding physical controller of the plurality of physical controllers and being configured to perform a same function as the corresponding physical controller, wherein the plurality of virtual controllers are configured to communicate with the plurality of physical controllers and the control server by using different Internet protocol (IP) addresses; and a virtual controller management agent configured to perform at least one among generation, deletion, execution, termination, detection, and control of the plurality of virtual controllers.

The plurality of physical controllers may include a unitary controller; a network controller connected to the unitary controller via a first network and connected to the control server via a second network having a higher data transmission speed than that of the first network; and a direct digital controller (DDC) connected to the network controller and the control server via the second network. The plurality of virtual controllers may include a virtual unitary controller corresponding to the unitary controller; a virtual network controller corresponding to the network controller; and a virtual DDC corresponding to the DDC.

The virtual network controller may be configured to route a data packet between the control server and the virtual unitary controller.

The virtual network controller may be further configured to analyze first routing information included in a header of the data packet received from the control server, and transmit the data packet to the virtual unitary controller corresponding to a final destination of the data packet.

The first routing information may include at least one among a network number, a media access control (MAC) address, and a length of the MAC address of the virtual unitary controller corresponding to the final destination.

The virtual network controller may be further configured to, when a response data packet is received from the virtual unitary controller corresponding to the final destination in response to the data packet, add second routing information to a header of the response data packet and transmit the response data packet, to which the second routing information is added, to the control server, wherein the second routing information indicates the virtual unitary controller that transmitted the response data packet.

The second routing information may include at least one among a network number, a MAC address, and a length of the MAC address of the virtual unitary controller transmitting the response data packet.

The virtual controller management agent may be further configured to receive a set value for a simulation from a user and operate the plurality of virtual controllers according to the set value.

The set value may comprise one of an analog input value, a binary input value, and a pulse input value.

According to another exemplary embodiment, a building management system includes a plurality of physical controllers configured to control at least one piece of equipment in a building; a control server configured to control the plurality of physical controllers; and a virtual simulator connected to the plurality of physical controllers and the control server, the virtual simulator being configured to simulate operations of the plurality of physical controllers, wherein the virtual simulator comprises: a plurality of virtual controllers, each virtual controller of the plurality of virtual controllers corresponding to a corresponding physical controller of the plurality of physical controllers and being configured to perform a same function as the corresponding physical controller, wherein the plurality of virtual controllers are configured to communicate with the plurality of physical controllers and the control server by using different Internet protocol (IP) addresses; and a virtual controller management agent configured to perform at least one among generation, deletion, execution, termination, detection, and control of the plurality of virtual controllers.

The plurality of physical controllers may include a unitary controller; a network controller connected to the unitary controller via a first network and connected to the control server via a second network having a higher data transmission speed than that of the first network; and a direct digital controller (DDC) connected to the network controller and the control server via the second network. The plurality of virtual controllers may include a virtual unitary controller corresponding to the unitary controller; a virtual network controller corresponding to the network controller; and a virtual DDC corresponding to the DDC.

The virtual network controller may be configured to route a data packet between the control server and the virtual unitary controller.

The virtual network controller may be further configured to analyze first routing information included in a header of the data packet received from the control server and transmit the data packet to the virtual unitary controller corresponding to a final destination of the data packet.

The first routing information may include at least one among a network number, a MAC address, and a length of the MAC address of the virtual unitary controller corresponding to the final destination.

The virtual network controller may be further configured to, when a response data packet is received from the virtual unitary controller corresponding to the final destination, in response to the data packet, add second routing information to a header of the response data packet and transmit the response data packet, to which the second routing information is added, to the control server, wherein the second routing information indicates the virtual unitary controller that transmitted the response data packet.

The second routing information may include at least one among a network number, a MAC address, and a length of the MAC address of the virtual unitary controller transmitting the response data packet.

The virtual-controller management agent may be further configured to receive a set value for a simulation from a user and operate the plurality of virtual controllers according to the set value

The set value may comprise one of an analog input value, a binary input value, and a pulse input value.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a detailed block diagram of a general building management system;

FIG. 2 is a flowchart of a general process of establishing the building management system of FIG. 1;

FIG. 3 is a detailed block diagram of a building management system according to one embodiment;

FIG. 4 is a detailed block diagram of a virtual simulator according to one embodiment;

FIG. 5 is a block diagram illustrating a process of managing a virtual controller using a virtual-controller management agent according to one embodiment;

FIG. 6 is a diagram illustrating a user interface according to one embodiment;

FIG. 7 is a block diagram of a physical controller according to one embodiment;

FIG. 8 is a block diagram of a virtual controller according to one embodiment;

FIG. 9 is a block diagram illustrating a network stack of a building automation & control network (BACnet) according to one embodiment;

FIG. 10 is a block diagram illustrating a routing function of a network controller according to one embodiment;

FIG. 11 is a flowchart of a routing process performed by a virtual network controller according to one embodiment;

FIG. 12 is a diagram illustrating a structure of a header of a data packet for master slave token passing (MSTP) data virtualization according to one embodiment;

FIG. 13 is a flowchart of a process of transmitting a data packet to a virtual unitary controller via a virtual network controller, according to one embodiment;

FIG. 14 is a flowchart of a process of transmitting a data packet to a control server via a virtual network controller, according to one embodiment;

FIG. 15 is a diagram illustrating a user interface through which an analog input value is received using a virtual-controller management agent according to one embodiment;

FIG. 16 is a diagram illustrating a user interface through which an analog input value is received using a virtual-controller management agent according to another embodiment;

FIG. 17 is a graph showing a result of a simulation conducted according to an analog input value according to one embodiment;

FIG. 18 is a diagram illustrating a user interface through which a binary input value is received using a virtual-controller management agent according to another embodiment;

FIG. 19 is a diagram illustrating a user interface through which a binary input value is received using a virtual-controller management agent according to another embodiment;

FIG. 20 is a graph showing a result of a simulation conducted according to a binary input value according to an embodiment;

FIG. 21 is a diagram illustrating a user interface through which a pulse input value is received using a virtual-controller management agent according to an embodiment; and

FIG. 22 is a diagram illustrating a result of a simulation conducted according to a pulse input value according to one embodiment.

### DETAILED DESCRIPTION OF EXEMPLARY EMBODIMENTS

Exemplary embodiments of the present disclosure will be described in detail with reference to the accompanying drawings below. The following detailed description is provided to facilitate a comprehensive understanding of methods, apparatus, and/or systems to be described below. However, these embodiments are merely examples and thus the present disclosure is not limited thereto.

When embodiments to be described below, well-known functions, or constructions related to the present disclosure will not be described in detail when it is determined that they would obscure the present disclosure due to unnecessary detail. Terms used herein are defined in consideration of functions of the present disclosure and may thus be changed according to intentions of users or operators in the art, precedents, etc. Thus, the terms used herein should be defined based on the whole context of the present disclosure. The specific terms used in the detailed description are only used to describe embodiments and are not to be understood as being intended to restrict the scope of the present disclosure. As used herein, the singular forms “a,” “an,” and “the” are intended to include the plural forms as well, unless the context clearly indicates otherwise. It should be further understood that the terms “comprise” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

In some embodiments, the term “communication network” should be understood as including the Internet, one or more local area networks (LANs), wide area networks, cellular networks, mobile networks, other types of networks, and a combination thereof.

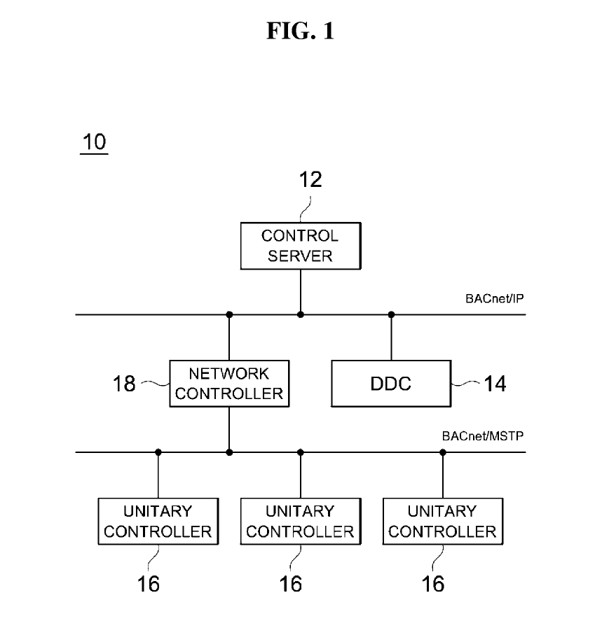

FIG. 1 is a detailed block diagram of a general building management system 10. As illustrated in FIG. 1, the building management system 10 includes a control server 12, a direct digital controller (DDC) 14, a unitary controller 16, and a network controller 18. Here, the DDC 14, the unitary controller 16, and the network controller 18 are physical controllers to be used to control one or more pieces of equipment in a building, and may be installed in the building. Several to several hundred such physical controllers may be installed according to a scale of the building. The control server 12 is a device which generally controls and monitors an overall situation of the building and may control the equipment in the building by managing and controlling the physical controllers 14, 16, and 18. The control server 12 may communicate with the DDC 14 and the network controller 18 via a building automation & control network (BACnet)/internet protocol (IP) network, which is a high-speed LAN. The network controller 18 may communicate with the unitary controller 16 via a BACnet/master slave token passing (MSTP) network, which is a low-speed LAN.

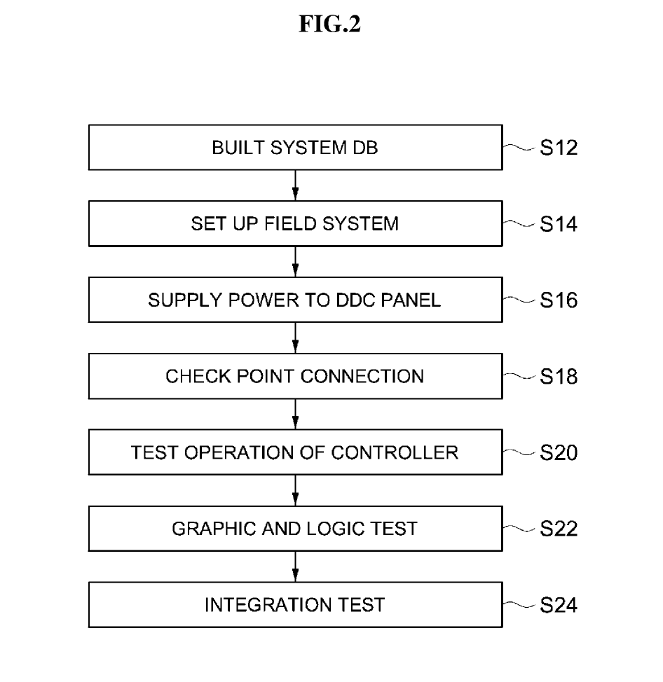

FIG. 2 is a flowchart of a general process of establishing the building management system 10 of FIG. 1.

First, a manager (or an engineer) builds a system database (DB) for operating a building by setting a connection and standards of equipment to be installed on each floor of the building, the physical controllers 14, 16, and 18 for controlling the equipment, and various input/output signals for controlling the equipment on the basis of plans of the equipment of the building (operation S12).

Next, the manager installs various pieces of equipment (a refrigerator, a boiler, an air conditioner, etc.) while establishing electrical and equipment systems of the building, and installs and sets the physical controllers 14, 16, and 18 for controlling the various pieces of equipment (operation S14).

Next, after electrical work for the building is completed, the manager supplies electrical power to the installed equipment and the physical controllers 14, 16, and 18 (operation S16).

Next, the manager checks states of cables and signals to determine whether an input/output signal is connected normally among the physical controllers 14, 16, and 18 and the various pieces of equipment installed in the building (operation S18).

Next, the manager checks a network connection state between the control server 12 and the physical controllers 14, 16, and 18 in the building, and tests whether the physical controllers 14, 16, and 18 operate normally by downloading information regarding the built system DB to the physical controllers 14, 16, and 18 (operation S20).

Next, the manager creates a graphic display including information regarding main states of the equipment in the building and control point information, and creates and tests a control logic (a control program) for the physical controllers 14, 16, and 18 so that the equipment may be automatically controlled by the physical controllers 14, 16, and 18 in a specific circumstance or condition (operation S22).

Lastly, when all of the setting work described above is completed, the manager conducts an integration test on the entire building management system 10 using the control server 12 (operation S24).

As described above, after the system DB is built according to the plan of the building, a large number of preparatory operations should be performed before graphic and logic tests and the integration test are conducted. Set up of such a field system, the electrical work, etc. depend on a process of constructing the building and requires a large amount of time. Thus, it is likely that the establishing and testing of the building management system 10 conducted at the last stage of a process of constructing the building will be delayed or unsatisfactorily completed. Furthermore, since the building management system 10 may be established and tested only after the construction of the building and the electrical work are completed, time may be unnecessarily wasted and engineers may be inefficiently managed.

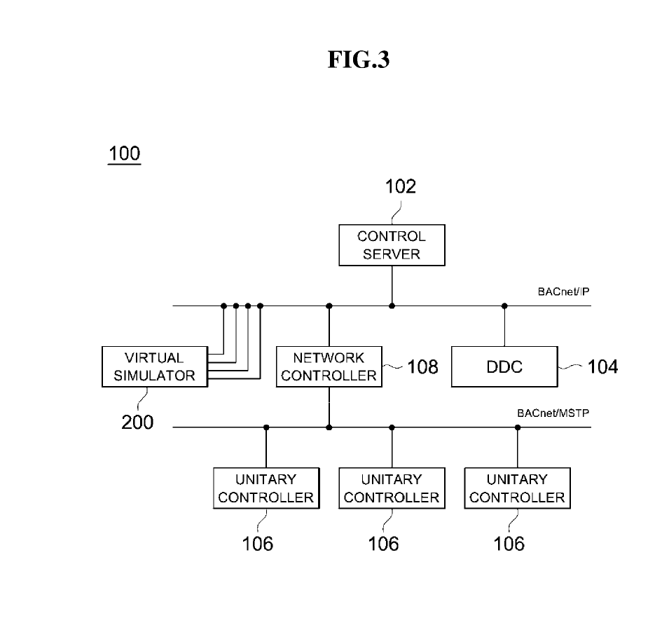

Accordingly, in embodiments, a means for efficiently establishing and testing a building management system 100 using a virtual simulator 200 without installing physical controllers is provided. The building management system 100 and the virtual simulator 200 according to an embodiment will be described in detail with reference to FIGS. 3 to 22 below.

FIG. 3 is a detailed block diagram of the building management system 100 according to one embodiment. Referring to FIG. 3, the building management system 100 according to on embodiment includes a control server 102, a DDC 104, a unitary controller 106, a network controller 108, and the virtual simulator 200.

The control server 102 is a device which generally controls and monitors an overall situation of a building, and may control equipment (or facilities) in the building by managing and controlling a plurality of physical controllers 104, 106, and 108. The control server 102 may register one or more control points corresponding to the equipment, and control the equipment using the control points. To this end, the control server 102 may create a graphic display including information regarding main states of the equipment and the control points, and create a control logic (or a control program) for the physical controllers 104, 106, and 108 so that the equipment may be automatically controlled by the physical controllers 104, 106, and 108 in a specific circumstance or condition. The control server 102 may be connected to the DDC 104, the network controller 108, and the virtual simulator 200 via a communication network, e.g., a transmission control protocol (TCP)/IP network, a BACnet, or the like. In the following embodiments, the term “equipment” is a general name, including various devices, machines, equipment, etc. which are installed in a building, and may be thus understood, for example, as an air conditioner, a boiler, a temperature/humidity sensor, a refrigerator, a light, an electrical power device, a fire system, etc.

The DDC 104 is a device positioned between the control server 102 and the equipment to control the equipment, and controls the equipment by communicating with the control server 102 to exchange information therewith and executing a control logic (or a control program) received from the control server 102. The DDC 104 may be, for example, a microcomputer which controls or monitors the equipment according to the control logic. The DDC 104 may monitor and control each of the control points regarding the equipment in the building, and directly control an input/output signal of the equipment using a function included in each of the control points.

The unitary controller 106 is a device which controls a specific operation of a single piece of equipment allocated thereto, and may be, for example, a variable air volume (VAV) controller, a light controller, or the like. The unitary controller 106 may control only an operation of the single piece of the equipment allocated thereto by being connected to the allocated equipment in a 1:1 manner. The unitary controller 106 is more limited than the DDC 104 in terms of function and use, and may be connected to the control server 102 via the network controller 108. The unitary controller 106 may be connected to the network controller 108 via a communication network (e.g., a BACnet/MSTP network or an RS-485 network) which has a lower transmission speed and is cheaper than that of the BACnet/IP network. However, the communication networks described above are merely examples and embodiments are not limited thereto. Hereinafter, for convenience of explanation, the communication network between the unitary controller 106 and the network controller 108 will be referred to as a first network, and the communication network between the control server 102 and the DDC 104 and between the network controller 108 and the virtual simulator 200 will be referred to as a second network.

The network controller 108 is a network conversion device performing data conversion between different networks (i.e., the first network and the second network), and may route a data packet between the control server 102 and the unitary controller 106. The network controller 108 may be connected to the unitary controller 106 via the first network, and may be connected to the control server 102, the DDC 104, and the virtual simulator 200 via the second network. As described above, the first network is a communication network which has a lower data transmission speed and is cheaper than the second network, and may use a serial communication protocol.

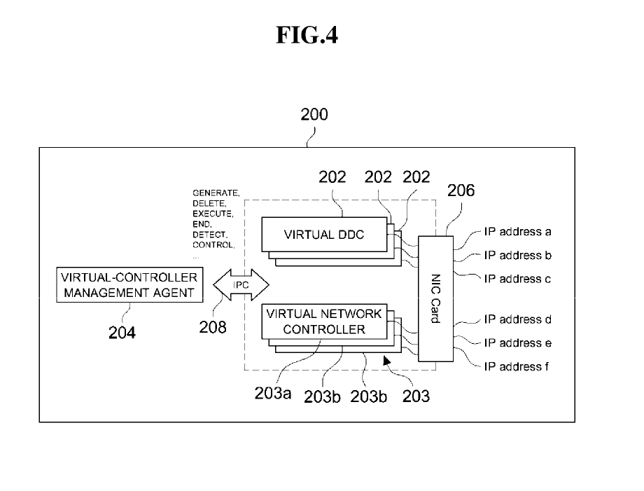

The virtual simulator 200 is a device which virtually simulates operations of the physical controllers 104, 106, and 108, and may be, for example, a desktop computer, a notebook computer, or the like. As illustrated in FIG. 3, the virtual simulator 200 may be connected to the control server 102, the DDC 104, and the network controller 108 via the second network, and may coexist with the physical controllers 104, 106, and 108 in a network. The virtual simulator 200 may virtually simulate the operations of the physical controllers 104, 106, and 108 using virtual controllers, which are modules configured to perform the same operations as the physical controllers 104, 106, and 108. The virtual controllers may be operated in the same installation environment as the physical controllers 104, 106, and 108, and may perform the functions of the physical controllers 104, 106, and 108. Each of the virtual controllers may correspond to one of the physical controllers 104, 106, and 108 and directly communicate with the control server 102 and the physical controller 104, 106, or 108 corresponding thereto using different IP addresses. In embodiments, the physical controllers 104, 106, and 108 may be tested and verified by virtually simulating management and operations thereof without installing the physical controllers 104, 106, and 108 in the building management system 100. Furthermore, the virtual simulator 200 may support a BACnet service and thus be integrated with another controller or system in the building via the BACnet. A structure and function of the virtual simulator 200 will be described in detail with reference to FIGS. 4 to 22 below.

FIG. 4 is a detailed block diagram of the virtual simulator 200 according to one embodiment. As illustrated in FIG. 4, the virtual simulator 200 according to an embodiment includes virtual controllers 202 and 203 and a virtual-controller management agent 204.

Each of the virtual controllers 202 and 203 is a module corresponding to one of the physical controllers 104, 106, and 108 and performing the same operation as the physical controller 104, 106, or 108 corresponding thereto. As illustrated in FIG. 4, the virtual controllers 202 and 203 may include a virtual DDC 202 corresponding to the DDC 104, a virtual network controller 203a corresponding to the network controller 108, and a virtual unitary controller 203b corresponding to the unitary controller 106. The virtual controllers 202 and 203 may be operated according to different processes and share one network interface card (NIC) 216, but may have different IP addresses. Thus, the control server 102 may recognize the virtual controllers 202 and 203 as different controllers. The virtual controllers 202 and 203 may include various application modules developed based on the same source code as various functional modules (e.g., an input/output signal processing block, an NXM module management block using RS-485 communication, a control logic performing block, a schedule management block, etc.) of the physical controllers 104, 106, and 108 corresponding thereto to perform the same functions as the physical controllers 104, 106, and 108.

The virtual-controller management agent 204 is a module managing the virtual controllers 202 and 203 and may perform, for example, functions of generating, deleting, executing, ending, detecting (or inquiring), and controlling the virtual controllers 202 and 203. The virtual-controller management agent 204 may include a user interface. Through the user interface, a manager may generate or delete the virtual controllers 202 and 203 or be connected to the virtual controllers 202 and 203 to execute, end, detect, or control them. In this case, the virtual-controller management agent 204 may manage individual processes of the virtual controllers 202 and 203 through inter-process communication (IPC) 208.

In one embodiment, the virtual controllers 202 and 203 and the virtual-controller management agent 204 may be realized in a computing device including one or more processors and a computer-readable recording medium connected to the one or more processors. The computer-readable recording medium may be located inside or outside the one or more processors, and may be connected to the one or more processors through various well-known means. The one or more processors included in the computing device may control the computing device to operate according to the embodiments set forth herein. For example, the one or more processors may execute a command stored in the computer-readable recording medium. When the command stored in the computer-readable recording medium is executed by the one or more processors, the computing device may operate according to the operations according to the embodiments set forth herein.

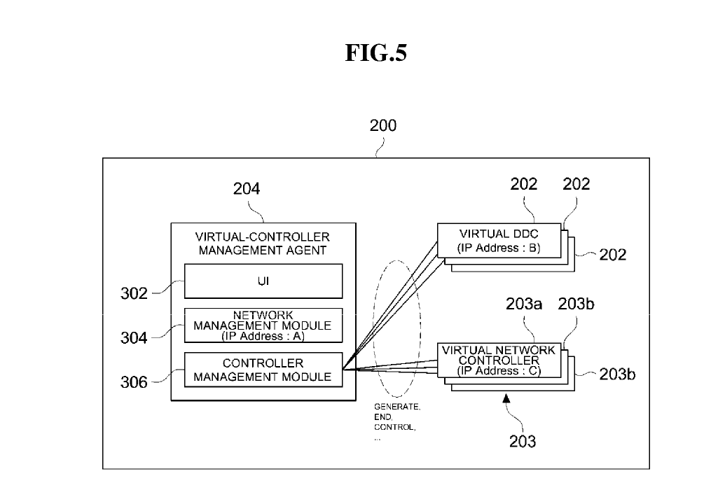

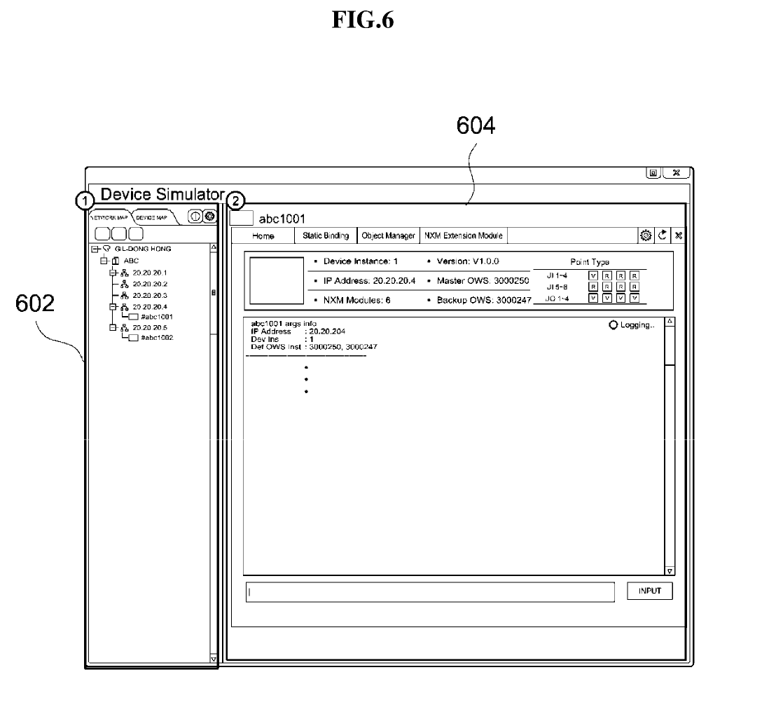

FIG. 5 is a block diagram illustrating a process of managing the virtual controllers 202 and 203 using the virtual-controller management agent 204 according to one embodiment. FIG. 6 is a diagram illustrating a user interface 302 according to one embodiment. As illustrated in FIG. 5, the virtual-controller management agent 204 includes the user interface 302, a network management module 304, and a controller management module 306.

The user interface 302 is a module providing a screen for managing each of the virtual controllers 202 and 203. Referring to FIG. 6, the user interface 302 may include an integrated management screen 602 and an individual management screen 604.

The integrated management screen 602 is a screen on which a list of the virtual controllers 202 and 203 are displayed. The list may be displayed, for example, in the form of a tree. In this case, each of the virtual controllers 202 and 203 may have a unique IP address. In the integrated management screen 602, the virtual controllers 202 and 203 may be displayed by being mapped to the IP addresses thereof. Thus, a manager may quickly view the list of the virtual controllers 202 and 203 and easily select a virtual controller to be controlled from among the virtual controllers 202 and 203.

The individual management screen 604 is a screen for displaying detailed information of the virtual controllers 202 and 203 selected or executed by the manager from among the virtual controllers 202 and 203 displayed on the integrated management screen 602. The individual management screen 604 may display the detailed information of the selected virtual controllers 202 and 203, for example, the IP addresses, versions, set-value (physical point) types, etc. of the virtual controllers 202 and 203. The manager may search for various detailed information of the virtual controllers 202 and 203 by clicking a menu, a button, or the like displayed on the individual management screen 604. The individual management screen 604 further provides a common line interface for the virtual controllers 202 and 203. Thus, the manager may control various operations (e.g., inputting/changing an input value for a simulation, conducting a simulation, outputting a result of the simulation, etc.) of the virtual controllers 202 and 203 by clicking the menu, the button, or the like.

The network management module 304 is a module managing a network of the virtual simulator 200 and may allocate different IP addresses to the virtual controllers 202 and 203. Thus, the virtual-controller management agent 204 and the virtual controllers 202 and 203 may have different IP addresses. In one embodiment, the IP address of the virtual-controller management agent 204 may be “A,” the IP address of the virtual DDC 202 #1 may be “B,” and the IP address of the virtual network controller 203a #1 may be “C.”

The controller management module 306 performs at least one function among generation, deletion, execution, ending, detection, and control of the virtual controllers 202 and 203. The controller management module 306 may receive a command instructing to perform the at least one function from the manager, and may perform the at least one function. Furthermore, the controller management module 306 may receive information regarding newly registered/deleted physical controllers 104, 106, and 108 from the control server 102 whenever the control server 102 newly registers/deletes the physical controllers 104, 106, and 108, and automatically generate/delete the virtual controllers 202 and 203 corresponding to the newly registered/deleted physical controllers 104, 106, and 108.

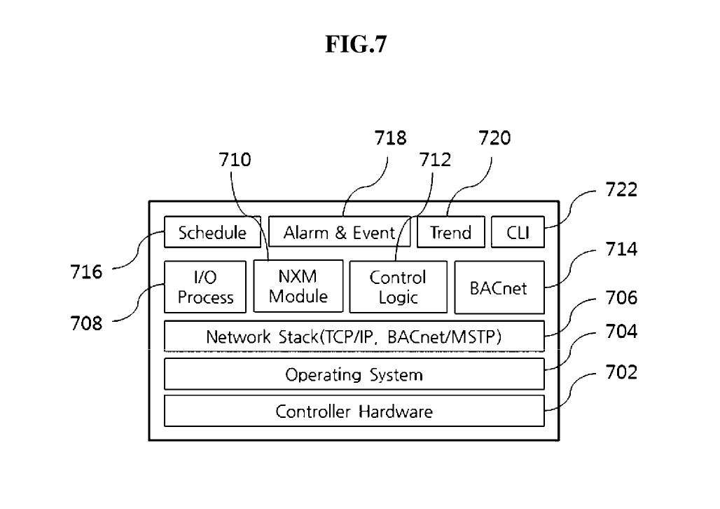

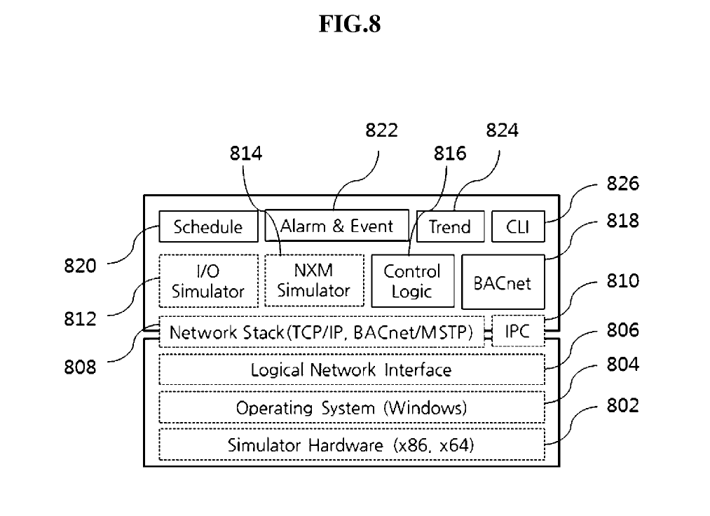

FIG. 7 is a block diagram of each of the physical controllers 104, 106, and 108 according to one embodiment. FIG. 8 is a block diagram of each of the virtual controllers 202 and 203 according to one embodiment.

Referring to FIG. 7, each of the physical controllers 104, 106, and 108 includes controller hardware 702, an operating system 704, a network stack 706, and various application modules 708 to 722.

The operating system 704 is software providing an environment in which the application modules 708 to 722 may be efficiently executed by the controller hardware 702.

The network stack 706 is a module providing a TCP/IP and BACnet/MSTP communication environment.

The application modules 708 to 722 include an input/output signal processing block 708, an NXM module management block 710 using RS-485 communication, a control logic execution block 712, a BACnet communication block 714, a block 716 managing a schedule of various operations of equipment, an alarm and event management block 718 which generates an alarm when a set condition is satisfied, a trend management block 720 which manages the trend of various operations of the equipment, and a command line interface (CLI) 722.

Referring to FIG. 8, each of the virtual controllers 202 and 203 includes simulator hardware 802, an operating system 804, a logic network interface 806, a network stack 808, an IPC 810, and various application modules 812 to 826.

The operating system 804 is software providing an environment in which the application modules 812 to 826 may be efficiently executed by the simulator hardware 802, and may be, for example, x86 or x64-based Windows. The logic network interface 806 is an interface supporting communication between the virtual controllers 202 and 203 and the control server 102 or between the virtual controllers 202 and 203 and the physical controllers 104, 106, and 108. The network stack 808 provides a TCP/IP and BACnet/MSTP communication environment. The IPC 810 connects the virtual controllers 202 and 203 and the virtual-controller management agent 204. The application modules 812 to 826 are modules developed based on the same source code as the application modules 708 to 722 of the physical controllers 104, 106, and 108, and may have the same structure or substantially the same structure as the application modules 708 to 722 of the physical controllers 104, 106, and 108.

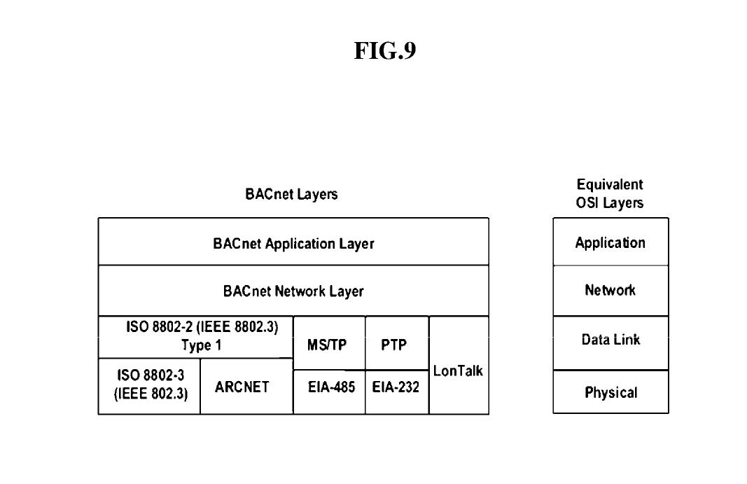

FIG. 9 is a block diagram illustrating a network stack of a BACnet according to one embodiment. The BACnet has a protocol structure having a hierarchical structure based on an OSI 7 Layer Model. The BACnet has five options, such as a LAN, an ARCNET, an MS/TP, a PTP, and LonTalk, as data link layers. The virtual simulator 200 may virtualize a LAN(BACnet/IP) and MS/TP communication which are popular and widely used.

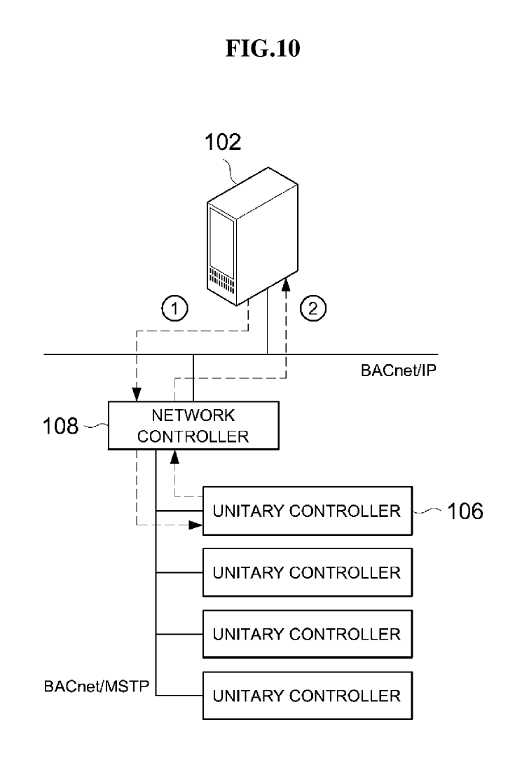

FIG. 10 is a block diagram illustrating a routing function of the network controller 108 according to one embodiment. As illustrated in FIG. 10, the network controller 108 may be connected to the control server 102 according to BACnet/IP and connected to the unitary controller 106 according to BACnet/MSTP.

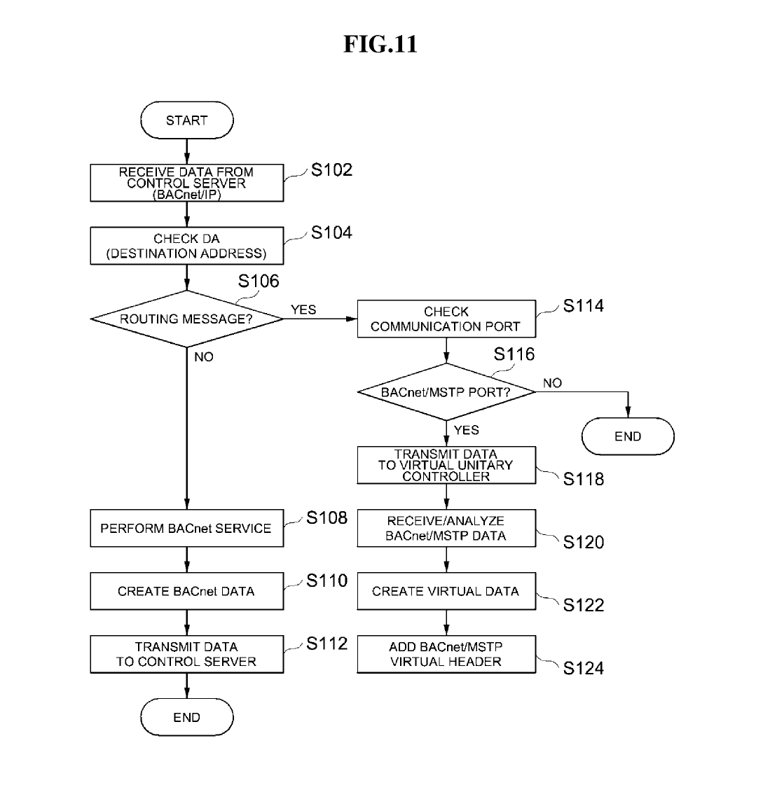

The network controller 108 transfers a BACnet/IP data packet received from the control server 102 to the unitary controller 106 which is the final destination of the data packet. During the transfer of the BACnet/IP data packet, a data structure of the BACnet/IP data packet may be converted into a BACnet/MSTP structure. Furthermore, the network controller 108 may convert a data structure of a BACnet/MSTP response data packet received from the unitary controller 106 into a BACnet/IP structure. That is, the network controller 108 may function both as a network conversion device and a router. A method of virtualizing the routing function of the network controller 108, which is performed by the virtual network controller 203a, will be described in detail with reference to FIGS. 11 to 14 below.

FIG. 11 is a flowchart of a routing process performed by the virtual network controller 203a according to one embodiment.

First, the virtual network controller 203a receives a data packet from the control server 102 via BACnet/IP (operation S102).

Next, the virtual network controller 203a analyzes the data packet received from the control server 102 to determine a final-destination address of the data packet (operation S104).

Next, the virtual network controller 203a determines whether the data packet is a routing message on the basis of the final-destination address of the data packet (operation S106). When the final-destination address of the data packet is an IP address of the virtual unitary controller 203b, the virtual network controller 203a may determine that the data packet is a routing message. When the final-destination address of the data packet is an IP address of the virtual network controller 203a, the virtual network controller 203a may determine that the data packet is not a routing message.

When it is determined in operation S106 that the data packet is not a routing message, the virtual network controller 203a performs a BACnet service (operation S108) and creates BACnet data (operation S110). That is, the virtual network controller 203a may perform various services related to the data packet without changing a structure of the data packet and then create a response data packet.

Next, the virtual network controller 203a transmits the response data packet to the control server 102 (operation S112).

When it is determined in operation S106 that the data packet is a routing message, the virtual network controller 203a checks a communication port of the virtual network controller 203a (operation S114).

When a BACnet/MSTP communication port of the virtual network controller 203a is present, the virtual network controller 203a transmits the data packet to the virtual unitary controller 203b, which is the final destination, via the BACnet/MSTP communication port (operations S116 and S118).

Next, the virtual network controller 203a receives a BACnet/MSTP response data packet from the virtual unitary controller 203b, analyzes the response data packet, and identifies the virtual unitary controller 203b transmitting the response data packet (operation S120).

Next, the virtual network controller 203a creates routing information indicating the virtual unitary controller 203b transmitting the response data packet (operation S122) and adds the routing information to a header of the response data packet (operation S124).

Lastly, the virtual network controller 203a transmits the response data packet to which the routing information is added to the control server 102 (operation S112).

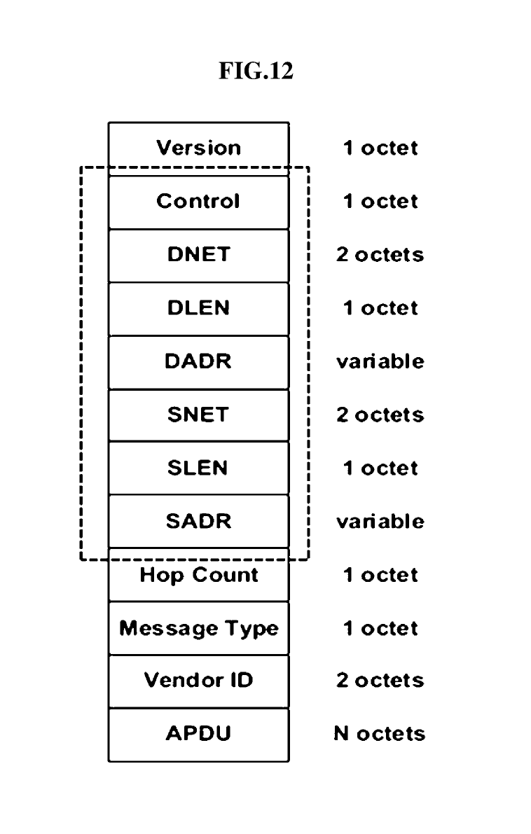

FIG. 12 is a diagram illustrating a structure of a header of a data packet for MSTP data virtualization according to one embodiment. As illustrated in FIG. 12, routing information (e.g., control, a destination network number (DNET), a destination address length (DLEN), a destination address (DADR), a source network number (SNET), a source address length (SLEN), and a source address (SADR)) required to route a data packet may be additionally defined in a header of a data packet routed by the virtual network controller 203a in addition to a source/destination address included in a header of a TCP/IP.

Here, “control” is a field for managing the DNET and SNET. The DNET, the DLEN, and the DADR will be referred to together as first routing information, and the SNET, the SLEN, and the SADR will be referred to together as second routing information.

The DNET is a network number of the virtual unitary controller 203b corresponding to the final destination. The DLEN is the length of a media access control (MAC) address of the virtual unitary controller 203b corresponding to the final destination. The DADR is the MAC address of the virtual unitary controller 203b corresponding to the final destination.

The SNET is a network number of the virtual unitary controller 203b transmitting the response data packet. The SLEN is the length of a MAC address of the virtual unitary controller 203b transmitting the response data packet. The SADR is the MAC address of the virtual unitary controller 203b transmitting the response data packet.

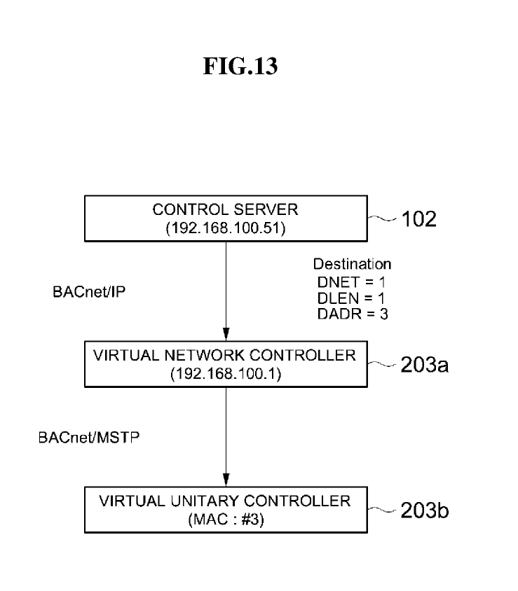

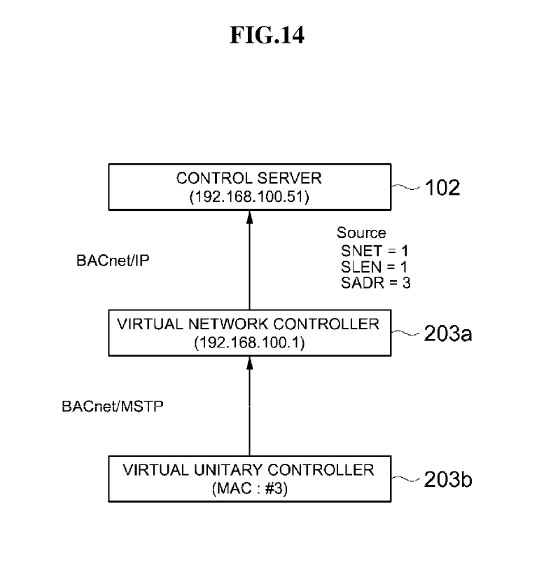

FIG. 13 is a flowchart of a process of transmitting a data packet to the virtual unitary controller 203b via the virtual network controller 203a, according to one embodiment. FIG. 14 is a flowchart of a process of transmitting a data packet to the control server 102 via the virtual network controller 203a, according to one embodiment.

Referring to FIG. 13, the control server 102 transmits a data packet to the virtual network controller 203a having an IP address of 192.168.100.1 so as to transmit the data packet to the virtual unitary controller 203b (a BACnet/MSTP network having a MAC address of #3), which is the final destination. The virtual network controller 203a may analyze the first routing information, which includes the DNET, the DLEN, and the DADR, contained in a header of the data packet received from the control server 102, and transmit the data packet to the virtual unitary controller 203b corresponding to the final destination of the data packet.

Referring to FIG. 14, the virtual unitary controller 203b transmits a response data packet to the virtual network controller 203a to transmit the response data packet to the control server 102 which has an IP address of 192.168.100.51 and is the final destination. The virtual network controller 203a may add, to a header of the response data packet, the second routing information, which includes the SNET, the SLEN, and the SADR and indicates the virtual unitary controller 203b transmitting the response data packet, and transmit the response data packet to which the second routing information is added to the control server 102 corresponding to an address of the final destination (i.e., the IP address of 192.168.100.51).

As described above, the virtual network controller 203a may route a data packet between the control server 102 and the virtual unitary controller 203b using the first routing information and the second routing information included in the header of the data packet.

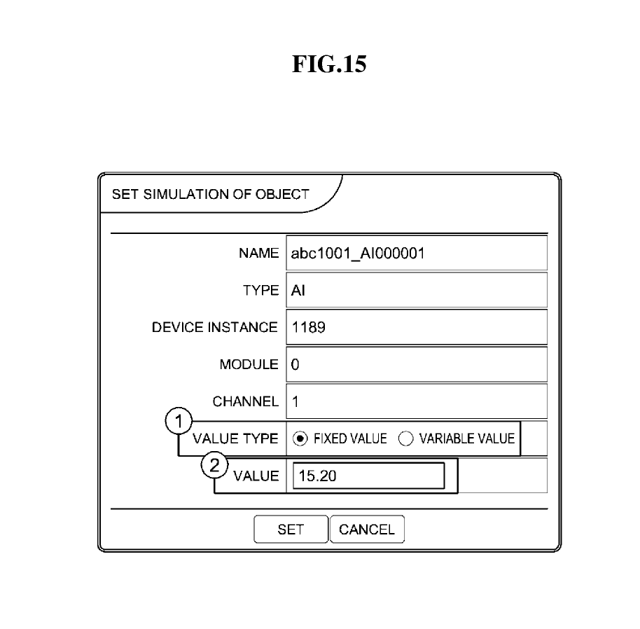

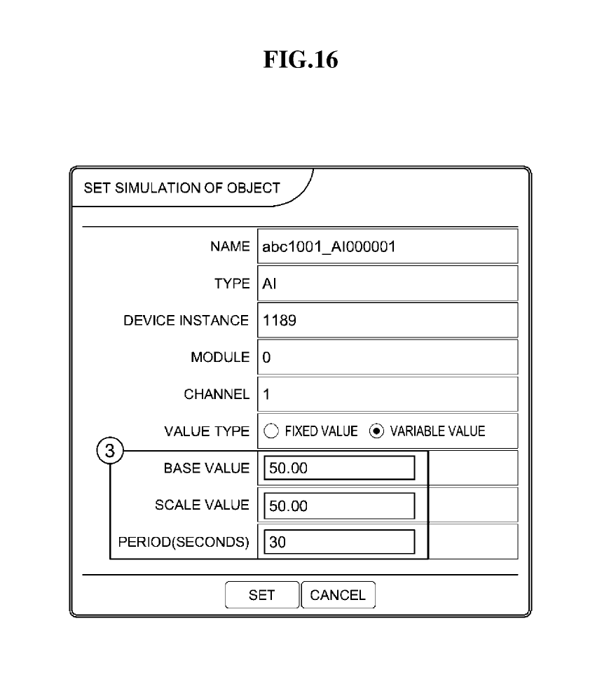

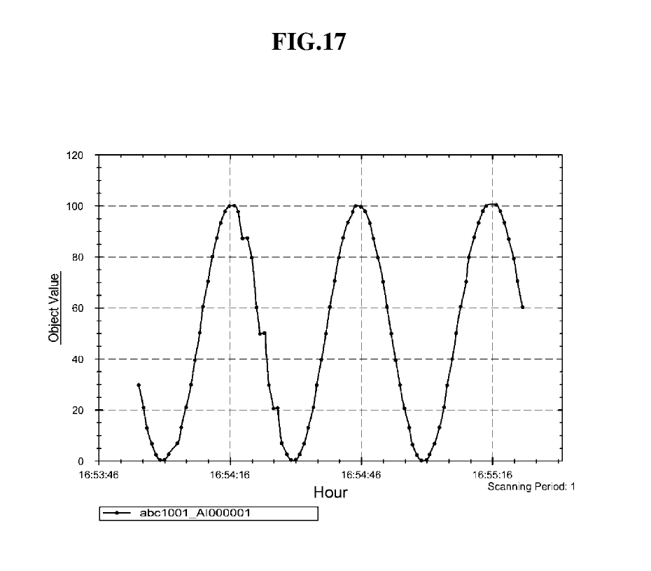

FIGS. 15 and 16 are diagrams illustrating user interfaces through which an analog input value is received using the virtual-controller management agent 204 according to embodiments. FIG. 17 is a graph showing a result of a simulation conducted according to an analog input value according to one embodiment.

The DDC 104 may include an input port and an output port to be used to monitor or control a state of equipment in a building. The input port may include an analog input port through which an analog input value AI, such as temperature or humidity, is received, a binary input port through which a binary input value BI indicating a driven state of the equipment or the like is received, a pulse input port through which a pulse input value PI such as the amount of electric power is received, etc.

Since an input signal is not actually supplied to the virtual DDC 202 operating in the virtual simulator 200, “0” is displayed when the control server 102 searches for an input port of the virtual DDC 202. Thus, the virtual controllers 202 and 203 provide a physical-point simulation function so that real equipment (e.g., a temperature sensor) may look as though it were connected to the input port. Here, the term “physical point” may be understood as including various values related to the equipment, e.g., temperature, humidity, a flow rate, a started/stopped state of the equipment, the amount of electric power, etc. A manager may input a set value and operate the virtual controllers 202 and 203 according to the set value to conduct a simulation regarding the physical point such that the physical point is changed as though a temperature thereof were changed by a real temperature sensor. The set value may be, for example, the analog input value AI, the binary input value BI, or the pulse input value PI.

Referring to FIG. 15, in order to maintain the analog input value AI to be constant, a manager selects a fixed value in a value type field \textcircled{1}, inputs the analog input value AI in a value field \textcircled{2}, and clicks a “SET” button. In this case, the analog input value AI may be maintained as the set value.

Referring to FIG. 16, the manager selects a variable value in the value type field \textcircled{1} so that the analog input value AI may be continuously changed to be similar to an input value of a real sensor. In this case, the value field \textcircled{2} is changed to a field \textcircled{3}. Here, a BASE value indicates a reference value, a SCALE value indicates a degree of change of a value, and a period (seconds) indicates a value change interval.

When the analog input value AI is input to the virtual simulator 200 by the manager, the virtual simulator 200 may operate the virtual controllers 202 and 203 according to the analog input value AI.

Referring to FIG. 17, a result of a simulation conducted according to the analog input value AI exhibits a sine curve form.

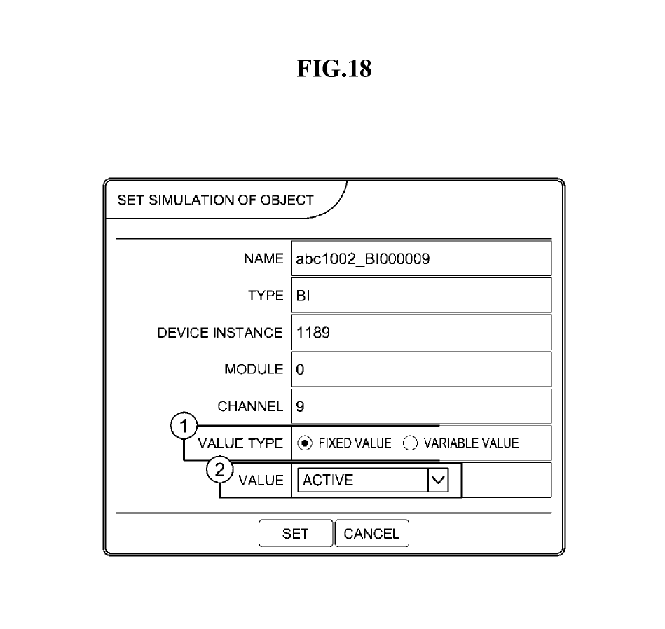

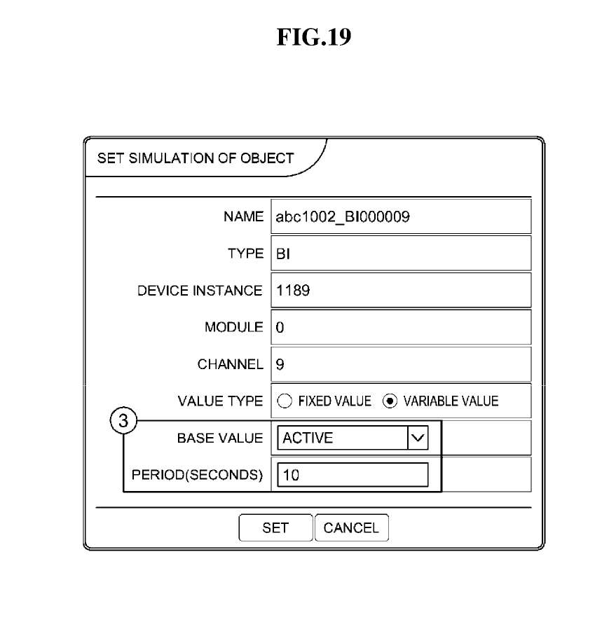

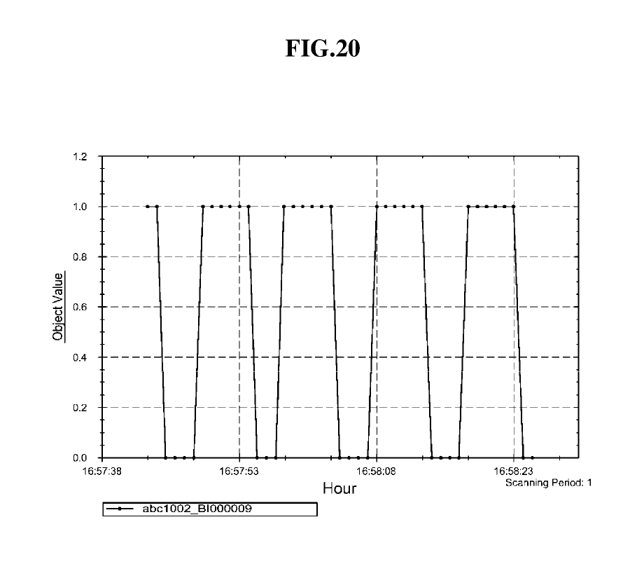

FIGS. 18 and 19 are diagrams illustrating user interfaces through which a binary input value is received using the virtual-controller management agent 204 according to embodiments. FIG. 20 is a graph showing a result of a simulation conducted according to a binary input value according to another embodiment.

Referring to FIG. 18, in order to maintain the binary input value BI to be constant, a manager selects a fixed value in a value type field \textcircled{1}, inputs the binary input value BI in a value field \textcircled{2}, and clicks a “SET” button. In this case, the binary input value BI may be maintained to be the set value.

Referring to FIG. 19, the manager selects a variable value in the value type field \textcircled{1} so that the binary input value BI may be variable. In this case, the value field \textcircled{2} is changed to a field \textcircled{3}. Here, a BASE value indicates a reference value, and a period (seconds) indicates a value change interval. Since the binary input value BI is “0” or “1”, a value of a corresponding object is changed to “0” or “1” at intervals set according to the BASE value when the variable value is set, as illustrated in FIG. 20.

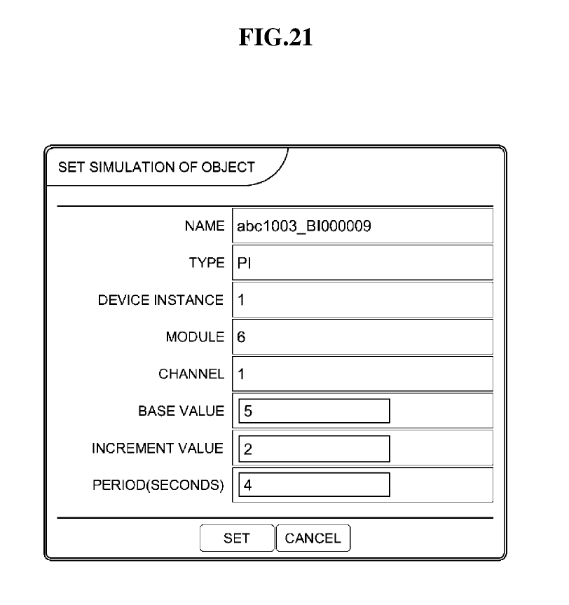

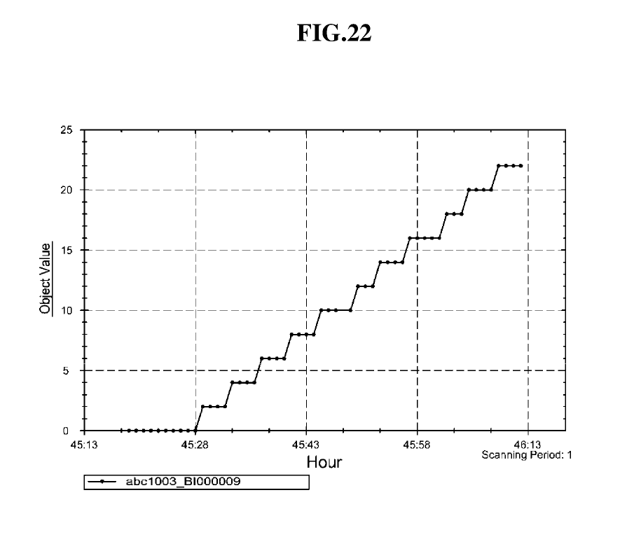

FIG. 21 is a diagram illustrating a user interface through which a pulse input value is received using the virtual-controller management agent 204 according to another embodiment. FIG. 22 is a diagram illustrating a result of a simulation conducted according to a pulse input value according to one embodiment.

Referring to FIG. 21, the pulse input value PI may include a BASE value, an INCREMENT value, and a period (seconds). Here, the BASE value indicates a reference value, the INCREMENT value indicates a degree of increase of a value, and the period (seconds) indicates an accumulated interval of a value.

Referring to FIG. 22, a corresponding point value increases by the INCREMENT value whenever the set period is increased according to the BASE value.

According to embodiments, an operation of a physical controller may be virtually simulated by operating a virtual controller capable of performing the same functions as the physical controller in the same environment as the physical controller even when the physical controller is not actually installed in a building. Thus, a load and performance test may be easily conducted on a control server and the physical controller, and a driving test may be easily conducted on equipment that is difficult or dangerous to test in a real environment. The virtual simulator is also applicable to building management education and training.

According to embodiments, different IP addresses are allocated to a plurality of virtual controllers, and thus the plurality of virtual controllers may be executed and managed simultaneously by one virtual simulator. Thus, a time and cost for constructing and testing a building management system may be minimized.

According to embodiments, a virtual simulator may be connected to a control server and a plurality of physical controllers via a network. Thus, the virtual simulator, the control server, and the plurality of physical controllers may coexist. In this case, operations of the plurality of physical controllers may be virtually simulated during a process of constructing a real building. Accordingly, waste of a system construction period and man-hours may be decreased and test-run efficiency of the plurality of physical controllers may be improved.

Furthermore, according to embodiments, a virtual controller may be operated by receiving various set values (physical points) related to an operation of the virtual controller from a manager. Thus, a simulation may be conducted in multiple ways according to the various set values.

Embodiments may include a program for performing the methods described herein in a computer, and a computer-readable recording medium storing the program. The computer-readable recording medium may store a program instruction, a local data file, a local data structure, or a combination thereof. The computer-readable recording medium may be designed and configured specially for the present disclosure or may be a recording medium commonly used in the field of computer software. Examples of the computer-readable recording medium includes magnetic media such as a hard disk, a floppy disk, and a magnetic tape, an optical recording medium such as a CD-ROM and a DVD, and hardware devices such as a ROM, a RAM, and a flash memory which are specially configured to store and execute program instructions. Examples of the program include not only machine language code prepared by a compiler but also high-level language code executable by a computer using an interpreter.

While exemplary embodiments have been described in detail above, it would be apparent to those of ordinary skill in the technical field to which the present disclosure pertains that various changes may be made to these embodiments in form and details without departing from the scope of the present disclosure. Therefore, it should be understood that the scope of the present disclosure is not limited to these embodiments and is defined in the claims and their equivalents.

What is claimed is:

1. A virtual simulator connected to a plurality of physical controllers, controlling at least one piece of equipment in a building, and a control server, controlling the plurality of physical controllers, for simulating operations of the plurality of physical controllers, the virtual simulator comprising:
a plurality of virtual controllers, each virtual controller of the plurality of virtual controllers corresponding to a corresponding physical controller of the plurality of physical controllers and being configured to perform a same function as the corresponding physical controller, wherein the plurality of virtual controllers are configured to communicate with the plurality of physical controllers and the control server by using different Internet protocol (IP) addresses; and
a virtual controller management agent configured to perform at least one among generation, deletion, execution, termination, detection, and control of the plurality of virtual controllers.

2. The virtual simulator of claim 1, wherein the plurality of physical controllers comprises:
a unitary controller;
a network controller connected to the unitary controller via a first network and connected to the control server via a second network having a higher data transmission speed than that of the first network; and
a direct digital controller (DDC) connected to the network controller and the control server via the second network, and
wherein the plurality of virtual controllers comprises:
a virtual unitary controller corresponding to the unitary controller;
a virtual network controller corresponding to the network controller; and
a virtual DDC corresponding to the DDC.

3. The virtual simulator of claim 2, wherein the virtual network controller is configured to route a data packet between the control server and the virtual unitary controller.

4. The virtual simulator of claim 3, wherein the virtual network controller is further configured to analyze first routing information included in a header of the data packet received from the control server, and transmit the data packet to the virtual unitary controller corresponding to a final destination of the data packet.

5. The virtual simulator of claim 4, wherein the first routing information comprises at least one among a network number, a media access control (MAC) address, and a length of the MAC address of the virtual unitary controller corresponding to the final destination.

6. The virtual simulator of claim 4, wherein the virtual network controller is further configured to, when a response data packet is received from the virtual unitary controller corresponding to the final destination in response to the data packet, add second routing information to a header of the response data packet and transmit the response data packet, to which the second routing information is added, to the control server, wherein the second routing information indicates the virtual unitary controller that transmitted the response data packet.

7. The virtual simulator of claim 6, wherein the second routing information comprises at least one among a network number, a MAC address, and a length of the MAC address of the virtual unitary controller transmitting the response data packet.

8. The virtual simulator of claim 1, wherein the virtual controller management agent is further configured to receive a set value for a simulation from a user and operate the plurality of virtual controllers according to the set value.

9. The virtual simulator of claim 8, wherein the set value comprises one of an analog input value, a binary input value, and a pulse input value.

10. A building management system comprising:
a plurality of physical controllers configured to control at least one piece of equipment in a building;
a control server configured to control the plurality of physical controllers; and
a virtual simulator connected to the plurality of physical controllers and the control server, the virtual simulator being configured to simulate operations of the plurality of physical controllers,
wherein the virtual simulator comprises:
a plurality of virtual controllers, each virtual controller of the plurality of virtual controllers corresponding to a corresponding physical controller of the plurality of physical controllers and being configured to perform a same function as the corresponding physical controller, wherein the plurality of virtual controllers are configured to communicate with the plurality of physical controllers and the control server by using different Internet protocol (IP) addresses; and
a virtual controller management agent configured to perform at least one among generation, deletion, execution, termination, detection, and control of the plurality of virtual controllers.

11. The building management system of claim 10, wherein the plurality of physical controllers comprises:
a unitary controller;
a network controller connected to the unitary controller via a first network and connected to the control server via a second network having a higher data transmission speed than that of the first network; and
a direct digital controller (DDC) connected to the network controller and the control server via the second network, and
wherein the plurality of virtual controllers comprises:
a virtual unitary controller corresponding to the unitary controller;
a virtual network controller corresponding to the network controller; and
a virtual DDC corresponding to the DDC.

12. The building management system of claim 11, wherein the virtual network controller is configured to route a data packet between the control server and the virtual unitary controller.

13. The building management system of claim 12, wherein the virtual network controller is further configured to analyze first routing information included in a header of the data packet received from the control server and transmit the data packet to the virtual unitary controller corresponding to a final destination of the data packet.

14. The building management system of claim 13, wherein the first routing information comprises at least one among a network number, a MAC address, and a length of the MAC address of the virtual unitary controller corresponding to the final destination.

15. The building management system of claim 13, wherein the virtual network controller is further configured to, when a response data packet is received from the virtual unitary controller corresponding to the final destination, in response to the data packet, add second routing information to a header of the response data packet and transmit the response data packet, to which the second routing information is added, to the control server, wherein the second routing information indicates the virtual unitary controller that transmitted the response data packet.

16. The building management system of claim 15, wherein the second routing information comprises at least one among a network number, a MAC address, and a length of the MAC address of the virtual unitary controller transmitting the response data packet.

17. The building management system of claim 10, wherein the virtual controller management agent is further configured to receive a set value for a simulation from a user and operate the plurality of virtual controllers according to the set value

18. The building management system of claim 17, wherein the set value comprises one of an analog input value, a binary input value, and a pulse input value.
